(19) United States
(12) Patent Application Publication
(10) Pub. No.: US 2014/0362611 A1
(43) Pub. Date: Dec. 11, 2014

(54) ENERGY-SAVING POWER CONVERTER

(71) Applicant: Chicony Power Technology Co., Ltd., New Taipei City (TW)

(72) Inventor: Shih-Min LIN, New Taipei City (TW)

(21) Appl. No.: 13/910,795

(22) Filed: Jun. 5, 2013

(51) Int. Cl. H02M 3/335

(52) U.S. Cl. CPC H02M 3/33592
USPC 363/21.14

(57) ABSTRACT

A transformer primary side of a transformer starts storing energy when a first switch unit is turned on. A transformer secondary side auxiliary winding of the transformer generates a secondary side voltage. A voltage of a second input side of a comparison unit is higher than a voltage of a first input side of the comparison unit. The comparison unit is configured to turn off a second switch unit. The voltage of the second input side is lower than the voltage of the first input side when the first switch unit is turned off. The comparison unit is configured to turn on the second switch unit. A transformer secondary side of the transformer sends a secondary side current to a load apparatus through the second switch unit.

### BACKGROUND OF THE INVENTION

1. Field of the Invention

The present invention relates to a power converter, and especially relates to an energy-saving power converter.

2. Description of the Related Art

FIG. 2 shows a block diagram of the related art power converter. A related art power converter 50 is applied to a power supply apparatus 20 and a load apparatus 30. The related art power converter 50 is, for example, a flyback converter.

The related art power converter 50 includes a transformer 102, a first switch unit 104, a first switch controller 114, a diode 52, and an output side capacitor 118. The transformer 102 includes a transformer primary side 120 and a transformer secondary side 122.

The transformer primary side 120 is electrically connected to the power supply apparatus 20 and the first switch unit 104. The first switch controller 114 is electrically connected to the first switch unit 104. The diode 52 is electrically connected to the transformer secondary side 122, the output side capacitor 118, and the load apparatus 30.

The transformer primary side 120 starts storing energy when the first switch unit 104 is turned on (controlled by the first switch controller 114). The transformer secondary side 122 starts releasing energy through the diode 52 when the first switch unit 104 is turned off (controlled by the first switch controller 114). The content mentioned above is the basic working principle of the conventional flyback converter.

The structure of the related art power converter 50 mentioned above is very simple. However, the disadvantage of the related art power converter 50 mentioned above is that the conduction loss of the diode 52 is still too high.

### SUMMARY OF THE INVENTION

In order to solve the above-mentioned problems, an object of the present invention is to provide an energy-saving power converter.

In order to achieve the object of the present invention mentioned above, the energy-saving power converter is applied to a power supply apparatus and a load apparatus. The energy-saving power converter includes a transformer, a first switch unit, a second switch unit, and a comparison unit. The transformer includes a transformer primary side, a transformer secondary side, and a transformer secondary side auxiliary winding. The comparison unit includes an output side, a first input side, and a second input side. The transformer primary side is electrically connected to the power supply apparatus. The first switch unit is electrically connected to the transformer primary side. The second switch unit is electrically connected to the transformer secondary side and the load apparatus. The output side is electrically connected to the second switch unit. The first input side is electrically connected to the transformer secondary side auxiliary winding. The second input side is electrically connected to the transformer secondary side auxiliary winding. The transformer primary side starts storing energy when the first switch unit is turned on. The transformer secondary side auxiliary winding generates a secondary side voltage. A voltage of the second input side is higher than a voltage of the first input side. The comparison unit is configured to turn off the second switch unit. The voltage of the second input side is lower than the voltage of the first input side when the first switch unit is turned off. The comparison unit is configured to turn on the second switch unit. The transformer secondary side sends a secondary side current to the load apparatus through the second switch unit.

### BRIEF DESCRIPTION OF DRAWING

FIG. 1 shows a block diagram of the energy-saving power converter of the present invention.

FIG. 2 shows a block diagram of the related art power converter.

### DETAILED DESCRIPTION OF THE INVENTION

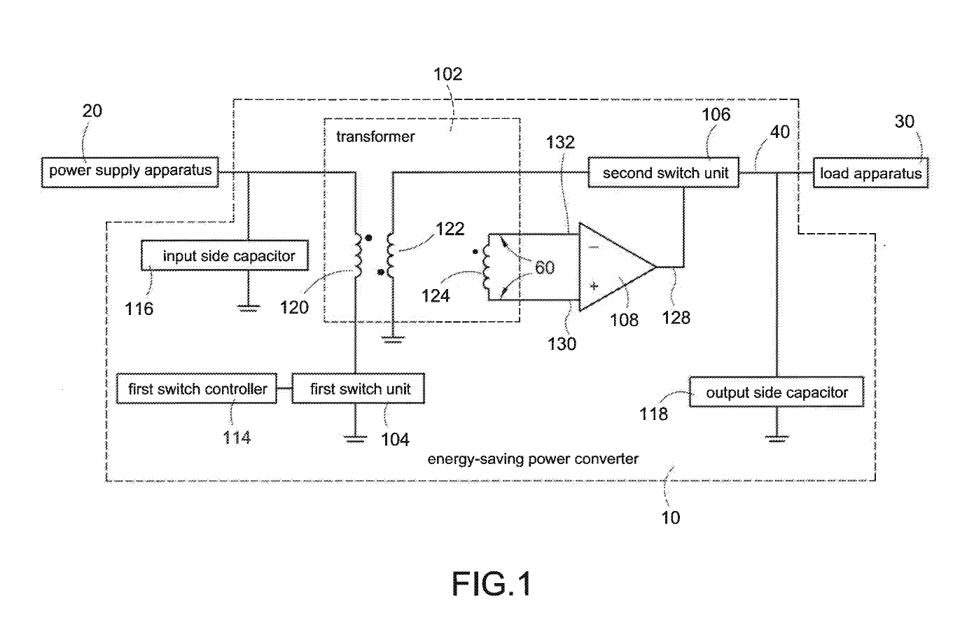

FIG. 1 shows a block diagram of the energy-saving power converter of the present invention. An energy-saving power converter 10 is applied to a power supply apparatus 20 and a load apparatus 30.

The energy-saving power converter 10 includes a transformer 102, a first switch unit 104, a second switch unit 106, a comparison unit 108, a first switch controller 114, an input side capacitor 116, and an output side capacitor 118.

The transformer 102 includes a transformer primary side 120, a transformer secondary side 122, and a transformer secondary side auxiliary winding 124. The comparison unit 108 includes an output side 128, a first input side 130, and a second input side 132.

The transformer primary side 120 is electrically connected to the power supply apparatus 20. The first switch unit 104 is electrically connected to the transformer primary side 120. The second switch unit 106 is electrically connected to the transformer secondary side 122 and the load apparatus 30.

The output side 128 is electrically connected to the second switch unit 106. The first input side 130 is electrically connected to the transformer secondary side auxiliary winding 124. The second input side 132 is electrically connected to the transformer secondary side auxiliary winding 124.

The first switch controller 114 is electrically connected to the first switch unit 104. The input side capacitor 116 is electrically connected to the power supply apparatus 20 and the transformer primary side 120. The output side capacitor 118 is electrically connected to the second switch unit 106 and the load apparatus 30.

The transformer primary side 120 starts storing energy when the first switch unit 104 is turned on (controlled by the first switch controller 114). The transformer secondary side auxiliary winding 124 generates a secondary side voltage 60 (at the second input side 132). A voltage of the second input side 132 is higher than a voltage of the first input side 130. The comparison unit 108 is configured to turn off (for example, output a low electric potential) the second switch unit 106.

The voltage of the second input side 132 is lower than the voltage of the first input side 130 (because the secondary side voltage 60 is generated at the first input side 130) when the first switch unit 104 is turned off (controlled by the first switch controller 114). The comparison unit 108 is configured to turn on (for example, output a high electric potential) the second switch unit 106. The transformer secondary side 122 sends a secondary side current 40 to the load apparatus 30 through the second switch unit 106. In another word, the transformer secondary side 122 starts releasing energy through the second switch unit 106 when the first switch unit 104 is turned off.

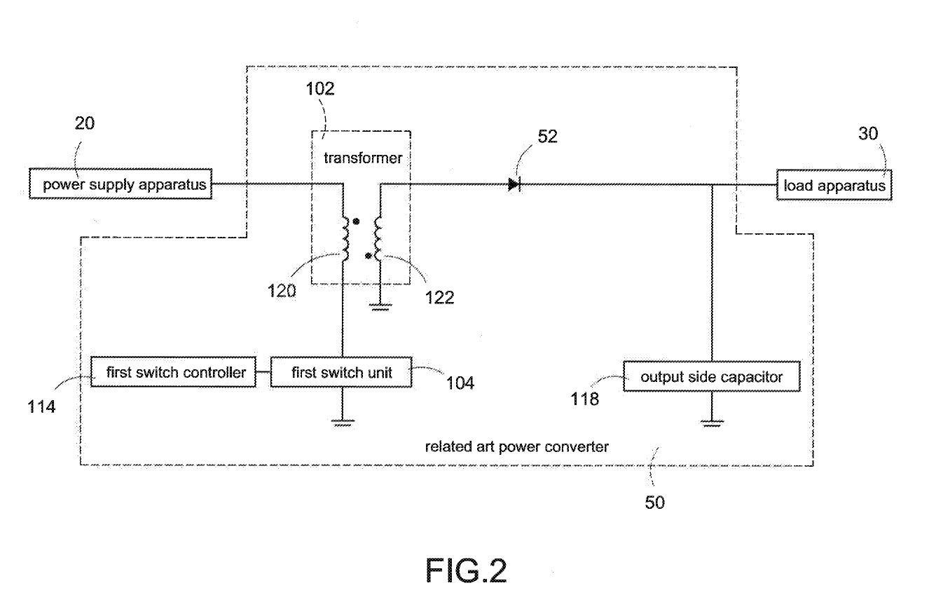

The conduction loss of the second switch unit 106 is less than the conduction loss of the conventional diode. Therefore, the conduction loss of the energy-saving power converter 10 is less than the conduction loss of the related art power converter 50 shown in FIG. 2 (the current is passing through the diode 52).

The comparison unit 108 is, for example but not limited to, a comparator, a power amplifier comparator circuit, or a differential comparator circuit.

The output side 128 is a comparator output side if the comparison unit 108 is a comparator. The first input side 130 is a comparator non-inverting input side. The second input side 132 is a comparator inverting input side.

The first switch unit 104 is, for example but not limited to, a metal oxide semiconductor field effect transistor, a bipolar junction transistor (BJT), or a silicon controlled rectifier.

The second switch unit 106 is, for example but not limited to, a metal oxide semiconductor field effect transistor, a bipolar junction transistor (BJT), or a silicon controlled rectifier.

The transformer 102 is, for example but not limited to, a flyback transformer, a forward transformer, an LLC (inductor-inductor-capacitor) resonant transformer, or a push pull transformer.

Moreover, the second switch unit 106 could be arranged at the low voltage side of the transformer secondary side 122 as well.

The present invention includes following features.

1. The transformer secondary side auxiliary winding 124 generates the secondary side voltage 60 when the first switch unit 104 is turned on. The voltage of the second input side 132 is higher than the voltage of the first input side 130. The comparison unit 108 is configured to turn off the second switch unit 106.

2. The voltage of the second input side 132 is lower than the voltage of the first input side 130 when the first switch unit 104 is turned off. The comparison unit 108 is configured to turn on the second switch unit 106. The transformer secondary side 122 sends the secondary side current 40 to the load apparatus 30 through the second switch unit 106.

3. The conduction loss of the second switch unit 106 is less than the conduction loss of the conventional diode. Therefore, the conduction loss of the energy-saving power converter 10 is less than the conduction loss of the related art power converter 50 shown in FIG. 2 (the current is passing through the diode 52).

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An energy-saving power converter applied to a power supply apparatus and a load apparatus, the energy-saving power converter including:
a transformer having a transformer primary side, a transformer secondary side, and a transformer secondary side auxiliary winding, the transformer primary side electrically connected to the power supply apparatus;
a first switch unit electrically connected to the transformer primary side;
a second switch unit electrically connected to the transformer secondary side and the load apparatus; and
a comparison unit having an output side, a first input side, and a second input side, the output side electrically connected to the second switch subunit, the first input side electrically connected to the transformer secondary side auxiliary winding, the second input side electrically connected to the transformer secondary side auxiliary winding,
wherein the transformer primary side starts storing energy when the first switch unit is turned on; the transformer secondary side auxiliary winding generates a secondary side voltage; a voltage of the second input side is higher than a voltage of the first input side; the comparison unit is configured to turn off the second switch unit; wherein the voltage of the second input side is lower than the voltage of the first input side when the first switch unit is turned off; the comparison unit is configured to turn on the second switch unit; the transformer secondary side sends a secondary side current to the load apparatus through the second switch unit.

2. The energy-saving power converter in claim 1, further including a first switch controller electrically connected to the first switch unit.

3. The energy-saving power converter in claim 2, further including an input side capacitor electrically connected to the power supply apparatus and the transformer primary side.

4. The energy-saving power converter in claim 3, further including an output side capacitor electrically connected to the second switch unit and the load apparatus.

5. The energy-saving power converter in claim 4, wherein the comparison unit is a differential comparator circuit.

6. The energy-saving power converter in claim 4, wherein the comparison unit is a power amplifier comparator circuit.

7. The energy-saving power converter in claim 4, wherein the comparison unit is a comparator; the output side is a comparator output side; the first input side is a comparator non-inverting input side; the second input side is a comparator inverting input side.

8. The energy-saving power converter in claim 4, wherein the first switch unit is a metal oxide semiconductor field effect transistor, a bipolar junction transistor, or a silicon controlled rectifier.

9. The energy-saving power converter in claim 4, wherein the second switch unit is a metal oxide semiconductor field effect transistor, a bipolar junction transistor, or a silicon controlled rectifier.

10. The energy-saving power converter in claim 4, wherein the transformer is a flyback transformer, a forward transformer, an inductor-inductor-capacitor resonant transformer, or a push pull transformer.
